(19) United States
(12) Patent Application Publication
(10) Pub. No.: US 2008/0256323 A1
(43) Pub. Date: Oct. 16, 2008

(54) Reconfiguring a Storage Area Network

(75) Inventors: Satish Kumar Mopur, Bangalore (IN); Sridhar Balachandriah, Bangalore (IN); Sudhindra Srinivasa Paraki, Bangalore (IN); Channabasappa Herur, Bangalore (IN); Anburaja Arumugam, Tirunelveli (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 12/100,279

(22) Filed: Apr. 9, 2008

(30) Foreign Application Priority Data
Apr. 9, 2007 (IN) 744/CHE/2007

(51) Int. Cl. G06F 11/07; G06F 12/00; G06F 12/02

(52) U.S. Cl. 711/173; 710/33; 711/170; 714/4; 714/E11.023; 711/E12.001; 711/E12.002; 711/E12.084

(57) ABSTRACT

The invention relates to a method and apparatus for reconfiguring a portion of a storage area network by establishing one or more auxiliary data paths, configuring the storage area network to re-route communications from the portion of the storage area network to be reconfigured to the one or more auxiliary data paths and reconfiguring the portion of the storage area network while the communications are being re-routed.

### RELATED APPLICATIONS

This patent application claims priority to Indian patent application serial no. 744/CHE/2007, titled “Reconfiguring a Storage Area Network”, filed on 9 Apr. 2007 in India, commonly assigned herewith, and hereby incorporated by reference.

### BACKGROUND OF THE INVENTION

Storage area networks (SANs) are high performance networks used to provide data connections for data transfer between data storage devices and host devices. For instance, a SAN can be used to provide a connection between a server and a disk array on which data to be accessed by the server is stored.

Switch-based zoning, also referred to as world wide name based zoning or port number based zoning, can be used in SANs to manage access to the storage devices so as to restrict each host device/host bus adaptor (HBA) to accessing only a particular storage device or a group of particular storage devices. A switch, also referred to as the fabric of the SAN, maintains a list of either the port addresses or the world wide names of the devices that are allowed to communicate with each other. The ports or world wide names that are allowed to communicate with each other are members of the same zone.

Logical unit number (LUN) masking is also used in SANs to control access to storage devices. Each storage device is provided a logical unit number. Each LUN is masked to all but a single host device/HBA, thus preventing host devices from accessing storage devices that have not been allocated to them or that they do not have permission to access.

With current trends for progressively larger volumes of stored data, high requirements for data availability and complex storage arrangements, demands on SAN implementations are increasing. To meet the demands, users expect highly effective, resilient and heterogeneous SAN infrastructures meeting high requirements specified in service level agreements (SLAs), such as high availability, performance and security requirements.

However, in known SAN implementations, the mapping or association of storage infrastructures to SLAs and the configuration of such infrastructures to meet the requirements of the SLAs has been a labour-intensive and slow process. Storage utilisation is tracked by users using management tools and any reconfiguration necessary as a result of changing SLAs or hardware availability can involve tedious manual processes and server down-time, which can be costly and result in inappropriate and accordingly inefficient connectivity provisioning.

Existing SAN planning and provisioning solutions provide facilities for effectively configuring and provisioning a SAN. However, these can have the drawback that SAN downtime is required when it is necessary to implement changes for connectivity provisioning. SANs using such solutions can fail to meet the business continuity requirements for the SANs described above.

### BRIEF DESCRIPTION OF THE DRAWINGS

Embodiments of the invention will now be described, by way of example, with reference to the accompanying drawings, in which:

FIG. 1 illustrates a host system and remote management station according to an embodiment of the present invention;

FIG. 2 is a flow diagram illustrating the steps performed according to the invention in configuring a storage area network;

FIG. 3 is a flow diagram illustrating the steps performed in creating segments in the method of FIG. 2; and

FIG. 4 is a flow diagram illustrating the steps performed according to the present invention in dynamically reconfiguring a storage area network.

### DETAILED DESCRIPTION OF THE INVENTION

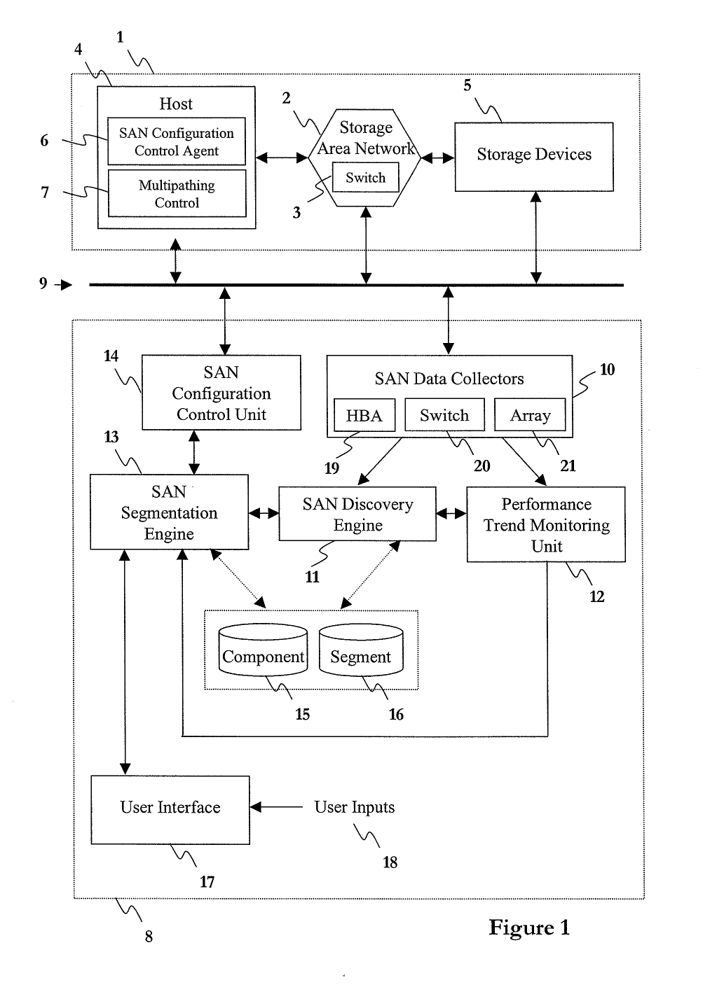

Referring to FIG. 1, a host system 1 includes a storage area network (SAN) 2 including one or more switches 3, also referred to as fabrics, connecting a plurality of host devices 4 to a plurality of storage devices 5. The host devices 4 each include a SAN configuration control agent 6 and a multipathing control unit 7 and can, for instance, be a server providing data services to a plurality of clients (not shown) based on the data stored at one or more of the storage devices 5. Each data service can, for instance, relate to a separate application, for which a service level agreement exists. The storage devices 5 are, in the present example, arrays of hard disks, the storage capacity being presented as a logical unit number (LUN) based on user requirements.

The host system 1 is connected to a remote management station 8 over a TCP/IP network 9. Other network configurations can be used additionally or in place of the network 9, for instance a network using the storage management initiative specification (SMI-S), a network configured to use the simple network management protocol (SNMP), or other network arrangements.

The remote management station 8 includes SAN data collectors 10 connected to a SAN discovery engine 11 and a performance trend monitoring unit 12, the discovery engine 11 and monitoring unit 12 also being interconnected and being separately connected to a SAN segmentation engine 13, which is in turn connected to a SAN configuration control module 14. The SAN segmentation engine 13 and SAN discovery engine 11 are also connected to a SAN component database 15 and to a SAN segment database 16. A user interface 17, used to display information to a user and to receive user inputs 18, is connected to the SAN segmentation engine 13. The SAN configuration control module 14 and SAN data collectors 10 are connected to the host system 1 via the network 9.

The term segment refers to a zone or multiple zones in the fabric 3 with associated connectivity from a host bus adapter (HBA) of one of the host devices 4 to a logical unit number (LUN) of a storage device 5. Segments can be deployed based on user SLA requirements. The segmentation process is the process of connectivity provisioning between the host devices 4 and storage devices 5 using zoning and/or LUN association to host devices according to user requirements.

The SAN discovery engine 11 is used to determine the physical connectivity of the SAN 2 based on data received from the SAN data collectors 10.

The SAN data collectors 10 include HBA collectors 19 for collecting data relating to the HBAs of the host devices 4, switch collectors 20 for collecting data relating to the SAN switches 3 of the SAN 2 providing connectivity between the host devices 4 and the storage devices 5, and array collectors 21 for collecting data relating to the storage devices 5. The data collectors 10, in particular, collect identification information identifying the existence and/or status of components of the host system 1, which is fed into a SAN connectivity graph builder module (not shown).

The SAN configuration control module 14 includes a zoning control module for creating and deleting zones using both an interface to the switches 3 of the SAN 2 and an interface to the storage devices 5, the interfaces being provided over the network 9 using interfaces such as SMI-S or SNMP. The SAN configuration control module 14 also includes a LUN association module that associates LUNs of the storage devices 5 with corresponding HBAs of the host devices 4, through configuration means such as SMI-S. The LUN association module is also arranged to perform LUN masking.

The SAN configuration control module 14 also includes a multipath control module for setting load balancing policies for re-routing data during reconfiguration of the SAN 2 and for restoring the original load balancing policies after the reconfiguration, using the host based multipathing control unit 7 over the TCP/IP network 9.

The SAN segmentation engine 13 is responsible for initial provisioning of connectivity in the SAN 2 based on user requirements received as user inputs 18 and the SAN configuration determined by the SAN discovery engine 11.

The performance trend monitoring unit 12 records performance data in the SAN 2 such as throughput over a period of time and reports to the SAN segmentation engine 13 on the over/under utilisation of resources in the SAN 2.

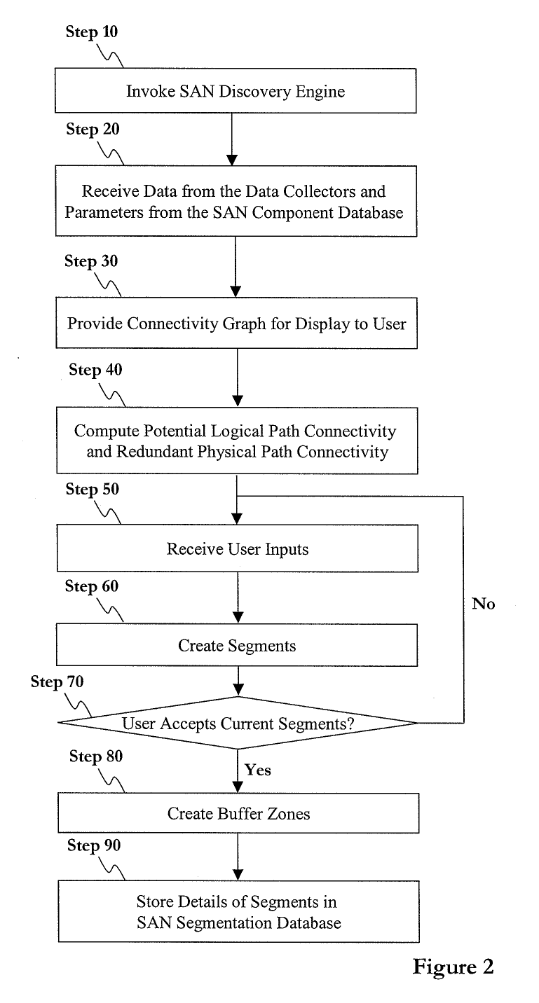

Operation of the remote management station 8 in segmenting the storage area network in accordance with a user inputted SLA will now be described with reference to FIG. 2. It is assumed that the SAN 2 has been divided into fabrics based on SAN design principles and that the user has performed provisioning for storage using storage provisioning tools for all devices in the fabrics. Provisioning for storage involves, in the present example, the mapping of storage requirements to the storage devices, taking account of SLA requirements for segment attributes such as performance, high availability and security.

The SAN discovery engine 11 is invoked (step 10) and receives data from the SAN data collectors 10 regarding the SAN 2, as well as information from the SAN component database 15 (step 20) concerning component abilities such as performance abilities relating to speed and scalability. The user is presented, at the user interface 17, with a detailed connectivity graph, produced by the SAN connectivity graph builder module, illustrating the connectivity of the SAN 2 as determined by the SAN discovery engine 11 (step 30).

Potential logical path connectivity based on the SAN components is then computed by the SAN discovery engine 11, as well as redundant physical path connectivity to storage devices 5 (step 40). User inputs 18 are received at the user interface 17 (step 50) indicating required service levels, for instance those specified in service level agreements, for each application of the SAN 2. The user inputs 18 include high availability (HA) requirements, such as the required percentage of logical connectivity to the end storage devices 5 and/or the required percentage of physical component redundant connectivity to the end devices 5, the percentage range of expected performance of the end devices 5, and the commonality requirements across applications or servers, for instance application or server groups using common zones as configured in switches. The inputs can also include exclusion requirements across applications or servers, for instance application groups requiring separate HBAs and zones, for instance to be implemented using WWN based zoning, and server grouping requirements, for instance server groups using common zones.

The user can also indicate any resources that are intended to be set aside initially, for potential use in the future, for instance for use in buffer zones used for re-routing communications while reconfiguring the SAN 2.

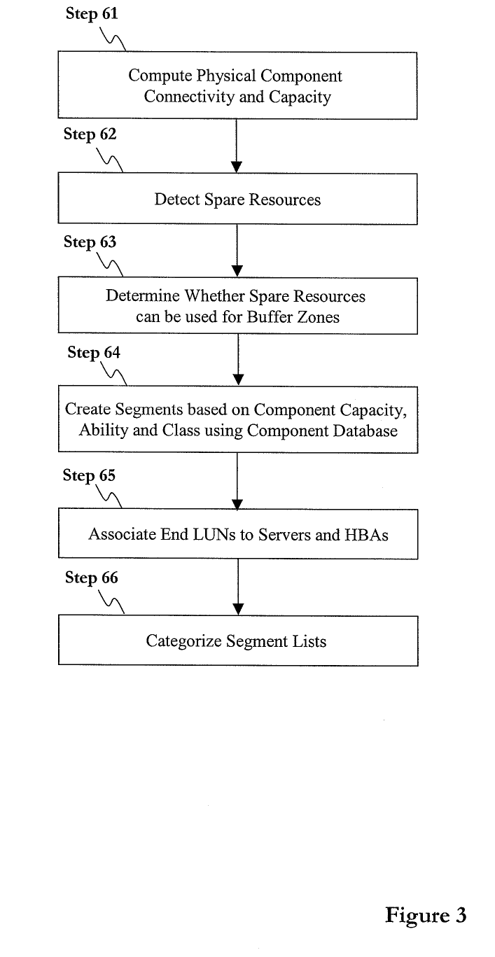

According to user requirements received via the user interface 17, segments, formed by single zones or unique subsets of zones, are created in the SAN 2 (step 60) in a process illustrated in the flow diagram of FIG. 3.

Referring to FIG. 3, the physical component connectivity, for instance the configuration of components and paths required, and capacity, for instance the number of paths required between the HBAs and storage devices 5, to meet the high availability requirements entered by the user, are calculated by the SAN segmentation engine 13, taking into account the existing SAN determined by the SAN discovery engine 11 and segment attributes entered by the user (step 61). Spare resources, if any, are then detected (step 62) and if the user intentionally set aside resources for future use, the user is prompted to indicate whether these can be used for buffer zones (step 63).

Segments are created according to the performance requirements received from the user for connections between the HBAs of the host devices 4 and storage devices 5, and based on the available component capacity, for instance the number of available ports, the parameters of the available components, such as the speed and class of the switches 3, for instance whether the switch is a director class switch or an edge switch (step 64). It is assumed that there are inter-switch links (ISLs) between switches in the SAN 2. Segment creation is performed by accessing the SAN component database 15, which can, for instance, be a Hewlett Packard component database, to access component parameters, and using the SAN configuration control unit 14 to implement the zones.

Associations between the LUNs of the storage devices 5 and the HBAs of the host devices 4 are implemented based on commonality and exclusion requirements specified by the user (step 65).

Segment lists are then categorised according to the user inputs with the attributes specified. For instance, the segments can be categorised according to the application that they are arranged to implement and listed along with their attributes such as the attributes received from the user relating to high availability, performance, inclusion/exclusion needs etc. Referring again to FIG. 2, the user input and segment creation processes (steps 50 and 60) are, in the present example, iterative processes, in which the user is firstly presented with a coarse configuration of SAN based on initial inputs, and the coarse SAN can then be fine-tuned according to further, more precise requirements, after this.

The user is prompted to accept the currently implemented segments (step 70) and, once the user accepts the segments, buffer zones are created (step 80) based on the amount of existing spare resources specified by the user. The buffer zones can be created using buffer components shared between all of the implemented zones or segments and/or by borrowing minimal resources from each zone or segment. Buffer zone resources are typically HBA/switch connectivity segments which may be an intersection of created zones. Buffer zones are used to provide one or more data paths, also referred to as auxiliary data paths, for input/output (I/O) rerouting when dynamic segmentation is performed (see below). Buffer zones can be utilised, when reconfiguration is not initiated, as normal zones, thus enabling effective resource utilisation. During reconfiguration, they can be used exclusively for re-routing data.

Details of all of the segments of the SAN 2 are then stored in the SAN segmentation database 16, for instance against the user inputted SLAs (step 90).

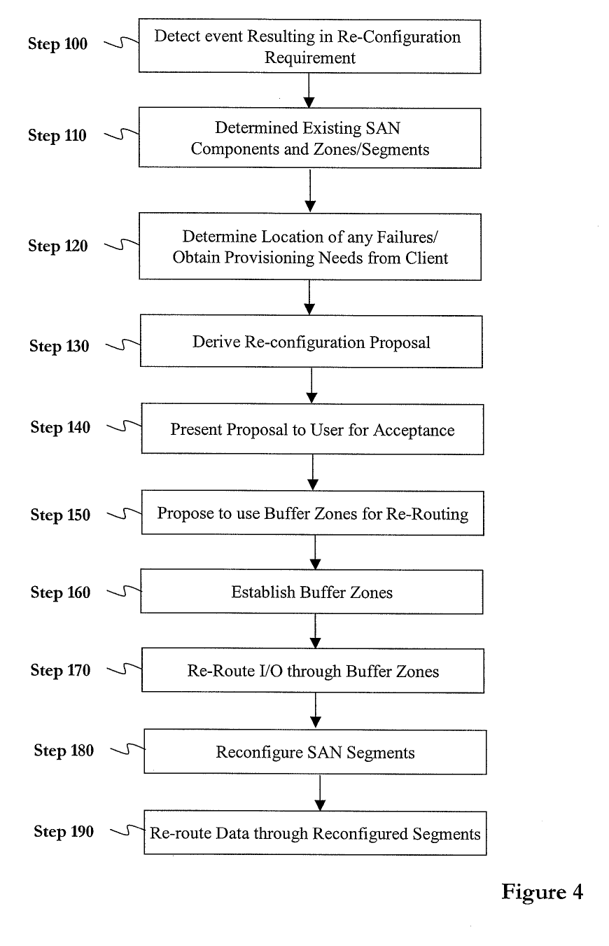

FIG. 4 is a flow diagram illustrating the steps performed according to the present invention in dynamically reconfiguring a SAN in response to an event that causes reconfiguration to be necessary.

An event that brings about a requirement for re-configuration of the SAN 2 is detected by the SAN segmentation engine 13 (step 100). Such an event can, for instance, be the user inputting new SLA requirement details, for instance if the user decides that the originally entered SLA requirements for applications need to be altered based on scheduled jobs or a critical requirement such as the failure of a component in a segment which results in a single point of failure. Alternatively, an event that brings about a requirement for reconfiguration of the SAN 2 can be a critical component failure impacting on a specific segment of the SAN 2, which demands re-provisioning of resources in order to minimise the impact of the failure on applications for that segment. Such a fault would, in the present example, be detected by the data collectors 10 and reported to the SAN segmentation engine 13 via the SAN discovery engine 11.

Once an event has been detected by the SAN segmentation engine 13, details of the existing SAN components are determined by the SAN segmentation engine 13, by accessing the SAN component details stored in the SAN component database 15.

The SAN segmentation engine 13 also determines information stored in the SAN segmentation database relating to the originally deployed segments and/or zones, or determines the current deployment of segments and/or zones by invoking the SAN discovery engine 11 to access the information via the SAN data collectors 10.

The location of any failures are determined if relevant, for instance the zone in which the failure has occurred and/or the specific component that has failed (step 120). Alternatively, if relevant, new SLA requirements are obtained from the user (step 120).

A new proposal for re-provisioning the SAN 2 is then calculated (step 130) by the SAN segmentation engine 13 and provided to the user for acceptance (step 140). Based on user specified policies, the SAN segmentation engine supports automatic re-provisioning in certain circumstances, for instance in the case of a detected failure, in which case providing a re-provisioning proposal to the user is not required.

If the user agrees to the proposed re-provisioning, the re-provisioning process proposes buffer zones to be used for re-routing input/output operations in the segments to be re-provisioned (step 150) to prevent disruption of these operations during re-provisioning, presenting these to the user via the user interface 17 for acceptance. Details of the buffer zones are obtained from the SAN segmentation database 16.

If the user accepts the use of the buffer zones, which they indicate via the user interface 17, the multipathing control unit 7 of the host device 4 establishes the buffer zones, or auxiliary data paths, through which input/output operations are to be routed (step 160) and the data is routed through the buffer zones (step 170). In particular, the multipath control module of the SAN configuration control module 14 sets load balancing policies for rerouting data using the host-based multipathing control unit 7 over the TCP/IP network 9. In this way, the auxiliary data paths can be used exclusively for re-routing data communications, such as input/output operations, from zones or segments being reconfigured. The configuration control agent at the host 4 can be triggered by the SAN configuration control unit 14 to activate the multipathing control unit 7, implemented in software at the host 4, to thus route the input/output operations through the data paths belonging to the buffer zones.

During the re-routing process, segment reconfiguration is initiated (step 180), this consisting of zone and/or segment reconfiguration which could involve port deletion or addition in the existing zones or segments, or deleting and recreating one or more of the existing zones or segments. LUN presentations to the HBAs are also performed in accordance with the new zones and/or segments comprising zones.

Following segment reconfiguration, the multipath control module of the SAN configuration control module 14 restores the original load balancing policies adopted by the host 4 using the host-based multipathing control 7 over the TCP/IP network 9. Accordingly, data is re-routed through the newly configured segments (step 190) from the buffer zones, thereby achieving desired service levels according to SLA requirements. Once reconfiguration is complete, the buffer zones are useable once again as normal zones, for instance as part of a particular segment of the SAN 2 in which they were used prior to reconfiguration.

In situations in which it may not be possible to re-provision the SAN without disruption of input/output operations, the SAN segmentation may propose a reconfigured SAN to a user via the user interface 17 which is effective in terms of meeting new or current SLA requirements, but involves temporary SAN downtime while the SAN is re-provisioned.

In alternative embodiments, in addition to the steps described above, it can be determined whether input/output operations are in progress in the segments/zones to be re-provisioned. In this case, the step of re-routing the input/output signals to the one or more auxiliary data paths can be performed only in the event that input/output operations are in progress and would therefore be disrupted.

1. A method of reconfiguring a portion of a storage area network having a plurality of data paths, the method comprising:
establishing one or more auxiliary data paths;
configuring the storage area network to re-route communications from a portion of the storage area network to be reconfigured to the one or more auxiliary data paths; and
reconfiguring the portion of the storage area network while the communications are being re-routed.

2. A method according to claim 1, comprising providing the one or more auxiliary data paths from one or more of the plurality of data paths of the storage area network outside the portion of the storage area network to be reconfigured.

3. A method according to claim 1, further comprising configuring the storage area network to re-route communications through the portion of the storage area network once reconfiguration is complete.

4. A method according to claim 1, further comprising arranging resources of the storage area network into a plurality of segments, wherein reconfiguring the portion of the storage area network comprises rearranging resources of the portion of the storage area network into one or more new segments.

5. A method according to claim 4, wherein arranging the resources of the storage area network into segments comprises arranging the resources into segments in accordance with a service level agreement.

6. A method according to claim 1, further comprising reserving resources of the storage area network for providing one or more data paths suitable for use as the auxiliary data paths.

7. A method according to claim 6, wherein the step of reserving resources of the storage area network comprises reserving a portion of one or more zones of the storage area network.

8. A method according to claim 1, further comprising automatically detecting a failure in a component of the storage area network.

9. A method according to claim 8, further comprising automatically determining the reconfiguration required in the portion of the storage area network as a result of the failure.

10. A method according to claim 1, further comprising receiving one or more parameter updates relating to the storage area network and automatically determining the reconfiguration required in the portion of the storage area network to comply with the parameter updates.

11. A method of segmenting a storage area network having a plurality of zones, the method comprising:
providing one or more buffer zones in the storage area network;
re-routing communications from a portion of the storage area network to be segmented to the one or more buffer zones; and
segmenting the portion of the storage area network while the communications are being re-routed.

12. Apparatus for reconfiguring a portion of a storage area network having a plurality of data paths, the apparatus comprising:
a data path controller arranged to establish one or more auxiliary data paths and to configure the storage area network to re-route communications from a portion of the storage area network to be reconfigured to the one or more auxiliary data paths; and
a configuration control unit arranged to reconfigure the portion of the storage area network while the communications are being re-routed.

13. Apparatus according to claim 12, wherein the data path controller is further arranged to establish the one or more auxiliary data paths outside the portion of the storage area network to be reconfigured.

14. Apparatus according to claim 12, wherein the data path controller is further arranged to configure the storage area network to re-route communications through the portion of the storage area network once reconfiguration is complete.

15. Apparatus according to claim 12, further comprising a segmentation unit, wherein the configuration control unit is configured to arrange resources of the storage area network into segments determined by the segmentation unit and wherein reconfiguring the portion of the storage area network comprises rearranging resources of the portion of the storage area network into one or more new segments determined by the segmentation unit.

16. Apparatus according to claim 15, wherein the segmentation unit is arranged to determine segments of the storage area network in accordance with a service level agreement.

17. Apparatus according to claim 15, wherein the segments each comprise one or more zones in the storage area network.

18. Apparatus according to claim 15, wherein the segmentation unit is arranged to reserve resources of the storage area network for providing the one or more auxiliary data paths.

19. Apparatus according to claim 18, wherein the reserved resources comprise a zone of the storage area network.

20. Apparatus according to claim 12, further comprising a database arranged to store information relating to components of the storage area network.
